(19) United States
(12) Patent Application Publication
(10) Pub. No.: US 2010/0309555 A1
(43) Pub. Date: Dec. 9, 2010

(54) Narrow angle filter

(76) Inventor: William H. Southwell, Thousand Oaks, CA (US)

Correspondence Address: William H. Southwell, 1421 Feather Ave, Thousand Oaks, CA, 91360, US

(21) Appl. No.: 12/455,838

(22) Filed: Jun. 8, 2009

(51) Int. Cl. G02B 5/28

(52) U.S. Cl. 359/586

(57) ABSTRACT

An optical interference coating that transmits light in a narrow angular band has been achieved. This filter works in filtering light from different angles of arrival when it is operated in a tilted configuration to the incoming signal. Two such tilted filters whose normal vectors are rotated about an optical axis by 90 degrees enable light from all polarizations and from all angles of arrival to be effectively filtered by angle.

### STATEMENT REGARDING FEDERALLY SPONSORED RESEARCH OR DEVELOPMENT

This invention was made with Government support under contract F36615-03-D-5408 awarded by U.S. Air Force to General Dynamics Information Technology, Inc. who subcontracted to Table Mountain Optics under Task Order No. USAF-5408-23-SC-0010-1 Modification #001. The Government has certain rights in the invention.

### CROSS-REFERENCE TO RELATED APPLICATIONS

Not Applicable

### FIELD OF THE INVENTION

This invention relates to an optical interference coating filter. In particular it relates to a coating that filters light according to its angle of arrival.

### BACKGROUND OF THE INVENTION

The theory and production of optical coatings are described in several books such as: Thin-Film Optical Filters by H. Angus Macleod, third edition, Taylor & Francis, New York (2001); Optical Coating Technology by Philip W. Baumeister, SPIE Press, Bellingham, Wash. (2004); and Practical Design and Production of Optical Thin Films by Ronald R. Willey, Second Edition, Marcel Dekker, Inc., New York (2002).

Optical interference coatings consist of multiple layers of optical materials having different values of refractive index. Typically, two materials are used, one having a high refractive index and the other one having a low refractive index. These layers are deposited on transparent substrates which are needed to support the multilayer stacks. The layers are typically very thin—usually less than the wavelength of the light. The spectral and angular properties, that is, the amount of light being reflected or transmitted at various wavelengths and angles, are determined by the number of layers and their thicknesses.

A common type of filter is a narrow band pass filter which only passes a narrow spectral wavelength region. Such filters are used to select light with specific spectral or color characteristics. Recently such narrow band pass filters have found useful application in optical communications with devices known as wavelength division multiplexer (WDM) filters. These are well known, well understood, and readily manufactured optical filters.

There is also a need to select light according to its angle of arrival. There is a need in the field of free space laser communication, for example, for an angle selective filter. Light entering the sensor from other field angles merely adds noise to the signal. I have discovered a new way to select light according to its angle of arrival using optical thin film filters. This cannot be done with filters for light near normal incidence using standard substrates and coating materials. The spectral thin film properties of multilayer coatings vary only slowly with angle at low angles of incidence. But an angle selective filter can be realized when two properly designed optical filters are used in tilted positions.

A telescope or lens, especially one with a long focal length, is a device that will select light according to its angular field of view. The optical filter angle filter of the present invention acts independently of lens angle-selective principle. The present invention may operate as a standalone device to select light according to its angle of arrival. It may also be used with a lens.

### BRIEF SUMMARY OF THE INVENTION

An optical interference coating design using standard substrates and coating materials that passes only a very narrow range of field angles has been developed. This filter operates at a tilted angle with respect to the sensor optical axis. Two such tilted filters are placed in front of the sensor where camera filters are usually positioned. The projection of the normal vectors of these two filters in a plane normal to the incoming light are rotated 90 degrees from each other. Since these two filters are tilted with respect to the direction of the incoming signal, they will require some thickness space not normally needed for spectral or color filters. Thus, for example in one application, they may be mounted in a tube much like a sun shade in front of the camera or sensor.

### BRIEF DESCRIPTION OF THE DRAWINGS

In the drawings:

FIG. 1 is a plot of transmittance in the meriodinal plane as a function of angle of incidence for light with wavelength of 1550 nm for an example coating design of this invention. Light is blocked from all angles except at 30 degrees plus or minus about one half degree.

FIG. 2 is a plot of the refractive index profile of the example narrow angle filter shown in FIG. 1. The layer materials are Si and SiO₂ and the substrate is fused silica.

FIG. 3 is a sketch of two narrow angle filters each tilted at 30 degrees from the optical axis and whose normal vector projections are rotated 90 degrees from each other azimuthally in a plane normal to the optical axis. In this sketch light travels down first through filter a then through filter b.

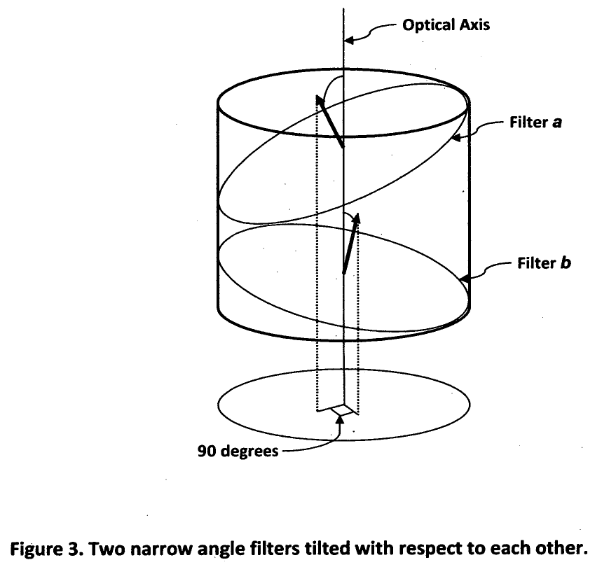

### DESCRIPTION OF THE INVENTION

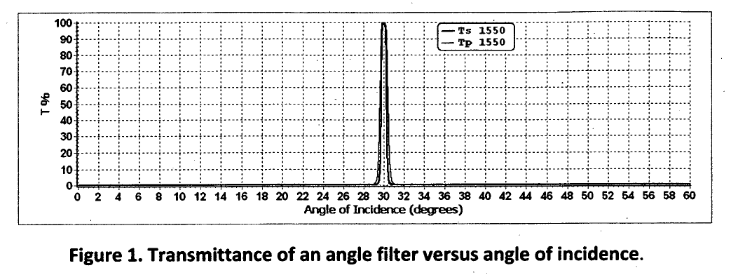

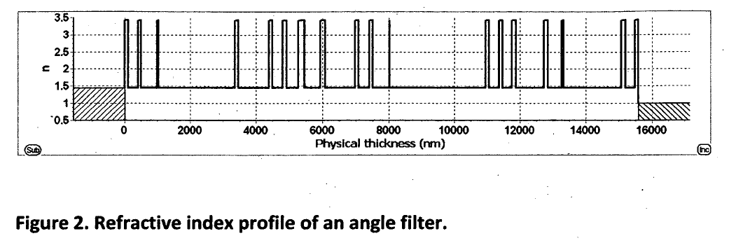

As described in the book Thin-Film Optical Filters by H. Angus Macleod, third edition, Taylor & Francis, New York (2001) pp. 283-292, all optical interference filters experience a spectral shift to lower wavelengths with increasing angle of incidence. For a spectral feature at the wavelength λ at zero degrees angle of incidence, this feature will shift to a shorter wavelength which is proportional to λ cos(θ) where θ is the angle of incidence. Since for a range of angles near zero the cosine function is still very close to one, there is essentially no change in the spectral properties for incidence angle changes near normal incidence. Thus, one cannot design an angle selective filter to operate near normal incidence. Normal incidence means light coming in perpendicular to the filter surface, which is defined as zero degrees angle of incidence. But for higher angles there is more angle shift. This spectral shift with angle around some higher reference angle or tilt angle is the basis for the angle filter of this invention. A thin film structure, consisting of many layers of high and low refractive index is constructed such that the transmittance of light at a given wavelength is high at a certain non-zero angle and the transmission will be low at other angles. This coating design is achieved by adjusting the layer thicknesses until the desired spectral properties are achieved. This process is called coating synthesis and is aided by computer optimization programs. This is a common practice by those experienced in the art of coating design. The designer defines a merit function which specifies the transmittance versus angle of incidence. This merit function might be, for example, to place a target of 100% transmittance at the angle band desired and target 0% transmittance at other angles: In this merit function it is important to specify transmittance for both s-polarized and p-polarized light to transmit at the same selected wavelength and angle of incidence. After the designer selects the coating materials, the software performs optimization on the layer thicknesses and the number of layers and then iteratively progresses until an acceptable performance is achieved. A plot of the transmittance of an example filter design is shown in FIG. 1. The filter layer configuration for this example is shown in FIG. 2.

When this angle filter alone is placed in front of the sensor at the designed tilt angle, it will still not function acceptably as a narrow angle filter. It will work for all rays entering the sensor that lie in the plane of incidence, which is defined by the plane containing the optical axis and the normal vector of the filter. But a comparable fan of rays lying in the perpendicular plane will exhibit only a small change in angle of incidence. This means the filter will pass rays lying in that perpendicular plane and not properly filter out those other field angles.

In this discussion it is important to distinguish between angle of incidence and field angle. The field angle is the angle from which the signal or supposed signal emanates. It is within the sensor field of view, which is a property of the sensor optics. The field angle is usually defined as the angle between the sensor optical axis and the ray of the incoming light. The angle of incidence is a property of the thin film filter and is defined as the angle between the incoming light and the surface normal unit vector. The field angle and the angle of incidence are not the same when the filter surface normal is tilted or not collinear with the optical axis.

One could envision an embodiment of this invention that uses only one tilted filter. One tilted filter would sufficiently filter rays from unwanted field angles when the filter is rotated until the normal vector lies in the plane containing the unwanted field angle. This means the field angle and angle of incidence are measured in the same plane. This is probably an unlikely situation as it would require knowing the plane of the field angle of the unwanted light and being able to rotate the filter accordingly. It would also require the unwanted light with different field angle azimuths to occur one at a time.

It occurred to the inventor that the use of two identical filters would enable the system to block light coming from any field angle other than the one specified in the design. The out-of-angle rays lying in the perpendicular plane that are not blocked by the first filter will be blocked by the second filter because its normal vector will be 90 degrees from the first filter's normal vector. It blocks light from unwanted field angles without knowing what they are and does so passively, that is, with no moving elements.

In this invention, the first filter is positioned in front of the sensor with its normal vector tilted with respect to the optical axis at the pass angle of incidence of the filter, as is described above. The second filter is positioned behind this filter in like manner with its normal vector tilted with respect to the optical axis at the pass angle of incidence of the filter. This second filter is then rotated about the optical axis until the normal vector points away from the optical axis in a direction that is 90 degrees from the normal vector of the first filter.

The operation of the filter may be understood by considering the incoming signal. This is along the optical axis of the sensor. Such light encounters the first filter at an angle of incidence of the filter's angle pass band. Regardless of the polarization of the incoming signal, the light is transmitted by the first filter because it is positioned or tilted at its pass band angle. Since the filter is tilted, the polarization components of the incident light are identified. The normal vector of the filter defines what p-polarized light is; it is the component of the electric field of the light that lies in the plane of incidence. The s-polarized light is the component of the electric field of the incident light that lies perpendicular to the plane of incidence. Any arbitrary state of polarization of the signal may be decomposed into a linear combination of s- and p-polarization states. Thus incident signal of any polarization will pass through this first filter because it is designed to pass both s- and p-polarization components at the same angle and wavelength. Now consider this light encountering the second filter. Since the second filter is tilted differently from the first filter, the resolution into polarized components changes. The second filter is tilted with its normal vector leaning away from the optical axis azimuthally 90 degrees from the first filter. Thus, what was p-polarized light at the first filter becomes s-polarized at the second filter. Likewise, what was s-polarized light at the first filter becomes p-polarized at the second filter. Since these two filters are tilted with respect to each other there will be no optical interference between them. Consequently, the total transmission of the two filters will be the product of the transmittances of each filter.

Let the incident signal be arbitrarily polarized so that the incident beam intensity Iᵢ=Iᵢₛ+Iᵢₚ, where Iᵢₛ and Iᵢₚ are the s- and p-polarized intensities of the incident signal. The final signal intensity after traversing both filters will be I_{f}=T_{bp}TₐₛIᵢₛ+T_{bs}TₐₚIᵢₚ, where Tₐₛ and Tₐₚ are the transmittances of the s- and p-polarization of the first filter, filter a, and T_{bs} and T_{bp} are the transmittances of the s- and p-polarization for the second filter, filter b. It would not have to be the case but there would be an advantage in making filters a and b identical. In that case, I_{f}=TₐₚTₐₛ(Iᵢₛ+Iᵢₚ) which says that the final beam will have the same polarization state as the incident signal. Also, when the filter design is such that the transmittances of the s- and p-polarizations are the same and nearly 100%, then the insertion loss for this filter system will be minimal.

When the filter coating is on one side of its substrate, system performance will benefit when the backside surface has an antireflection coating which is so designed to pass the signal wavelength at the filter tilt angle for both s- and p-polarizations. This is not a difficult design objective. However, there is an advantage to putting the narrow angle filter coating on the back sides of the substrates for both filters a and b. The throughput of the system will then be (TₐₚTₐₛ)². This has a dramatic effect of reducing the out-of-angle transmission, while minimally affecting the in-angle signal. For example, suppose the design has an out-of-angle transmission of 0.01 (1%) for both s- and p-polarizations, which is an optical density of 2. The two filter configuration would then result in an out-of-angle transmission of (0.01)²=0.0001 (0.01%) which is an optical density of 4. When the narrow angle filter coating is applied to the backsides of these filters, this out-of-angle transmission becomes (0.01)⁴=0.00000001 (0.000001%) which is an optical density of 8. Now if the in-angle transmission is 0.99 (99%) then the two coating configuration will have a transmission of (0.99)²=0.98 (98%). When the coatings are also applied to the backside, the transmission is (0.99)⁴=0.96 (96%). This high optical density for out-of-angle light rejection is important when there is a very bright source, such as the sun, close to the signal source angle. This will be important when trying to image exoplanets. Imaging planets like our own is extremely challenging: the light from an Earth-like planet may be a billion times or more fainter than the parent starlight, and the planet-to-star angular separation is very small.

### Stray Light Rejection

Another application for this invention is to reduce stray light in optical systems. When the narrow angle filter is placed in front of the entrance pupil of the system and is at least slightly oversized so that the stop surface for the system remains the limiting aperture and the entrance pupil remains the same, then the angle filter protects this aperture from bright out-of-angle radiation. This reduces spurious diffraction scattering from the pupil that contributes noise to the image plane.

Not only does the filter of this invention protect the entrance pupil, or aperture stop, from bright out-of angle sources, but it also protects such light from entering the pupil itself. Ordinarily such light bounces back and forth from the walls of the optical system and increases background noise at the image plane.

### Detailed Description of an Example Embodiment

New designs for narrow angle pass filters have been developed for various base angles of incidence using common optical coating materials and substrates. Good angle discrimination can be obtained at 45 degree angle of incidence. However, keeping the angle band widths equal for both polarizations favors smaller angles of incidence. Furthermore, smaller angles enable a more compact configuration when two filters are mounted. For illustrative purposes we shall describe one embodiment of this invention. It is a narrow angle pass filter that passes light of wavelength λ=1550 nm in an angle region of less than plus or minus 0.5 degree and rejects light from all other angles. This filter operates at a base angle of 30° with respect to the incident signal which it passes. This design also has excellent rejection at angles from normal out to at least 60 degrees as seen in FIG. 1. The angle band widths are nearly the same, although it is seen that the width for the p-polarized light is slightly wider.

It is seen in FIG. 2 that the optimization selected most of the coating to be the lower index material. This makes the net average index of the coating to be low. This increases the angle shift since generally the change in wavelength of an optical interference coating will vary as sin²θ/(2N)², where N is some average refractive index for the coating. The lower the average index the higher the angle shift and the higher the angle resolution possible with the design.

It is to be understood that other designs operating at other base angles and wavelengths are within the scope of this invention. It is also clear to one skilled in the art of optical thin film design that other materials and substrates may be substituted for those used in this example. Such modifications are also considered within the scope of this invention.

The following claims are made for this invention:

1. A method for filtering light in narrow angular ranges consisting of an assembly of optical thin film layers with prescribed refractive index values and thicknesses.

2. The method of claim 1 wherein the assembly of thin films is tilted at an angle relative to the desired signal direction.

3. The method of claim 1 wherein two such assemblies of thin films are positioned in series with their filter surface normal vectors rotated 90° around an optical axis.

4. A method for further reducing light from out-of-field directions consisting of applying the method of claim 1 on the front and back sides of two supporting substrates.

5. An optical filter that transmits light having a narrow angular pass range and rejects light from other angles which is comprised of optical thin films of different refractive indexes and layer thicknesses deposited on a substrate.

6. The optical filter of claim 5 wherein the substrate is tilted at an angle relative to the direction of the signal.

7. An optical filter consisting of two filters of claim 5 on separate substrates are positioned such that the filter normal vectors are rotated 90° from each other around the optical axis.

8. A narrow angle pass filter assembly consisting of two substrates positioned at an angle to each other and to the incoming beam wherein at least one of the surfaces of each substrate is coated with a narrow angle pass optical coating consisting of multiple layers of optical thin films having refractive index values of at least one material having a high refractive index and at least one material having a low refractive index and having prescribed thicknesses such that light is passed over a narrow angular range and rejects light from other angles and wherein the surface normal vectors of each filter substrate are positioned such that they are rotated 90° from each other about an optical axis.

9. A narrow angle pass filter assembly of claim 8 that is positioned in front of an optical receiver such that out-of-field-of-view sources will not illuminate the aperture.

10. The narrow angle pass filter assembly of claim 8 that is used with an optical receiver such that it reduces diffraction scattering arriving at the focal plane.

11. The narrow angle pass filter assembly of claim 8 that is used with an optical receiver such that it reduces surface scattering and reflection scattering arriving at the focal plane.
